(19) United States
(12) Patent Application Publication
(10) Pub. No.: US 2010/0325854 A1
(43) Pub. Date: Dec. 30, 2010

(54) METHOD FOR POLARIZING A PIEZOCERAMIC MATERIAL

(76) Inventor: Christian Reichinger, Neutraubling (DE)

Correspondence Address: King & Spalding LLP, 401 Congress Avenue, Suite 3200, Austin, TX, 78701, US

(21) Appl. No.: 12/867,639

(22) PCT Filed: Feb. 4, 2009
(86) PCT No.: PCT/EP09/51253

§ 371 Date: Aug. 13, 2010

(30) Foreign Application Priority Data
Feb. 27, 2008 (DE) 10 2008 011 414.6

(51) Int. Cl. H04R 17/00

(52) U.S. Cl. 29/25.35

(57) ABSTRACT

In a method for polarizing a piezoceramic material, first, a base is provided that is made of non-polarized piezoceramic material and has at least two opposite planar electrodes and at least one predetermined breaking point because of which a stress relief fracture forms when a voltage having a first voltage value is applied. A number of voltage pulses, the amplitudes of which follow a time-related envelope curve, is applied to the electrodes of the base. The amplitudes of the voltage pulses in a first section of the envelope curve are higher than the first voltage value, and the amplitudes of the voltage pulses in a second section of the envelope curve that follows the first section have a second voltage value which is sufficient to permanently polarize the piezoceramic material.

### CROSS-REFERENCE TO RELATED APPLICATIONS

This application is a U.S. National Stage Application of International Application No. PCT/EP2009/051253 filed Feb. 4, 2009, which designates the United States of America, and claims priority to German Application No. 10 2008 011 414.6 filed Feb. 27, 2008, the contents of which are hereby incorporated by reference in their entirety.

### TECHNICAL FIELD

The invention relates to a method for polarizing a piezoceramic material.

### BACKGROUND

Piezoceramic materials, such as e.g. lead-zirkonate-titanate, stretch when an electrical voltage is applied in a direction parallel to the electric field generated by the electrical voltage. Piezoceramic materials are used inter alia for piezoelectric actuators, by means of which the injection of fuel into a combustion engine is controlled, for example.

Piezoceramics have electric dipoles which initially are unpolarized. In order to enable the piezoelectric effect to be used the piezoceramic material must be polarized.

DE 100 28 335 B4 discloses a method for polarizing a piezoceramic material wherein, starting from a main body made from unpolarized ceramic material having at least two electrodes embodied with flat surfaces and disposed opposite each other, a number of voltage pulses are applied to the electrodes. The pulse heights of the voltage pulses follow a time-dependent envelope curve which in a first section increases during a rise time from a minimum electrical voltage to a maximum electrical voltage and which in a second section holds the maximum electrical voltage during a hold time. The minimum electrical voltage has a value such that when the electrodes are charged the maximum compatible charging of the still unpolarized piezoceramic material is undershot. The maximum electrical voltage is suitable for producing a permanent polarization of the piezoceramic material.

### SUMMARY

According to various embodiments, a method for polarizing a piezoceramic material can be provided which enables the unpolarized piezoceramic to be polarized faster.

According to various embodiments, a method for polarizing a piezoceramic material, may comprise the following method steps of: —providing a main body made from unpolarized piezoceramic material having at least two electrodes embodied with at least two flat surfaces and disposed opposite each other, and having at least one predetermined fracture joint due to which a strain-relieving crack forms when an electrical voltage having a first electrical voltage value is applied, and—applying a number of electrical voltage pulses to the electrodes, the pulse heights of which voltage pulses follow a time-dependent envelope curve, the pulse heights of the electrical voltage pulses in a first section of the envelope curve being greater than the first electrical voltage value and the pulse heights of the electrical voltage pulses in a second section of the envelope curve following the first section having a second electrical voltage value which is sufficient to produce a permanent polarization of the piezoceramic material.

According to a further embodiment, the first electrical voltage value can be greater than the second electrical voltage value. According to a further embodiment, the second electrical voltage value can be equal to the maximum permissible electrical voltage of a piezoelectric actuator for which the main body is provided. According to a further embodiment, the time period of the first section can be less than the time period of the second section, in particular the time period of the first section can be less than or equal to a quarter of the time period of the second section. According to a further embodiment, the envelope curve may have a third section preceding the first section, the pulse heights of the electrical voltage pulses of the third section having a third voltage value which is less than the second voltage value and is sufficient to incinerate a contaminant in particular in a passivation layer of the main body. According to a further embodiment, the time period of the first and the third section together can be less than the time period of the second section, in particular the time period of the first and the third section together can be less than or equal to a quarter of the time period of the second section. According to a further embodiment, the method may comprise: determining the electrical conductivity of the main body made from unpolarized piezoceramic material, deducing the degree of contamination and setting the third voltage value based on the determined degree of contamination. According to a further embodiment, the method may comprise: applying an electrical voltage of in particular around 10V to the electrodes in order to determine the electrical conductivity of the main body made from unpolarized piezoceramic material. According to a further embodiment, the method may comprise: applying to the main body, while the electrical voltage pulses are being applied, a force acting against the main body, which force corresponds in particular to a mean value of a force against which a piezoelectric actuator for which the main body is provided works at a mean stroke during operation. According to a further embodiment, the envelope curve may have a fourth section following the second section, the pulse heights of the electrical voltage pulses of the fourth section having a fourth voltage value which corresponds to a mean value of an electrical voltage that is applied during the operation of a piezoelectric actuator for which the main body is provided. According to a further embodiment, the time period of the fourth section can be less than the time period of the second section, in particular the time period of the fourth section can be less than or equal to half of the time period of the second section.

### BRIEF DESCRIPTION OF THE DRAWINGS

Exemplary embodiments are shown by way of example in the attached schematic drawings, in which:

FIG. 1 shows a piezoelectric stack having unpolarized piezoceramic material,

FIG. 2 shows the piezoelectric stack after its piezoceramic material has been polarized,

FIG. 3 shows a characteristic curve of an electrical voltage that is applied to the piezoelectric stack,

FIG. 4 shows an envelope curve of the electrical voltage,

FIG. 5 shows an alternative characteristic curve of an electrical voltage that can be applied to the piezoelectric stack of FIG. 1,

FIG. 6 shows an envelope curve of the electrical voltage of FIG. 5,

FIG. 7 shows a further characteristic curve of an electrical voltage that can be applied to the piezoelectric stack of FIG. 1, and

FIG. 8 shows an envelope curve of the electrical voltage of FIG. 7.

### DETAILED DESCRIPTION

As stated above, according to various embodiments, a method for polarizing a piezoceramic material, may comprise the following method steps of:
providing a main body made from unpolarized piezoceramic material having at least two electrodes embodied with flat surfaces and disposed opposite each other, and having at least one predetermined fracture joint, due to which a strain-relieving crack forms when an electrical voltage having a first electrical voltage value is applied, and
applying a number of electrical voltage pulses to the electrodes, the pulse heights of which voltage pulses follow a time-dependent envelope curve, the pulse heights of the electrical voltage pulses in a first section of the envelope curve being greater than the first electrical voltage value and the pulse heights of the electrical voltage pulses in a second section of the envelope curve following the first section having a second electrical voltage value which is sufficient to produce a permanent polarization of the piezoceramic material.

The main body made from unpolarized piezoceramic material is provided e.g. in order to be used for a piezoelectric actuator. For this to be possible the unpolarized piezoceramic material must be polarized. Furthermore the main body has one or more predetermined fracture joints on account of which one or more strain-relieving cracks form when the first electrical voltage is applied. By the selective guidance of said strain-relieving cracks through e.g. porous ceramic layers or porous electrode layers it is possible to increase the service life of a piezoelectric actuator using the main body. Predetermined fracture joints are disclosed inter alia in DE 10 2004 031 404 A1 and DE 102 34 787 C1.

Owing to the predetermined fracture joints it is possible, prior to the polarization of the unpolarized piezoceramic material by means of the electrical voltage pulses of the second section of the envelope curve, to apply the electrical voltage pulses of the first section of the envelope curve to the main body made from unpolarized piezoceramic material. The electrical voltage of the first section (first voltage value) is greater, in particular considerably greater, than an electrical voltage which, when applied, results in the formation of the strain-relieving crack or cracks.

The first voltage value can be in particular greater than the second voltage value, thereby increasing the efficiency of the method according to various embodiments.

Guiding the strain-relieving crack or cracks through the porous layers then ensures a selective propagation of the strain-relieving crack or cracks to a depth as of which the strain-relieving crack or cracks no longer tend toward a detrimental kinking.

The second section of the envelope curve can begin immediately after the electrical voltage pulses of the first section of the envelope curve have been applied to the main body. The second voltage value is high enough to be sufficient to bring about a permanent polarization of the piezoceramic material. The second voltage value is e.g. dependent on the piezoceramic material and/or the distance between two electrodes.

The second electrical voltage value can be equal to the maximum permissible electrical voltage of a piezoelectric actuator for which the main body is provided. The second voltage value is then the higher value from the electrical voltage by means of which a charging for permanent polarization is achieved or else the maximum permissible electrical voltage of the piezoelectric actuator.

All that is necessary in order for the strain-relieving cracks to form is to apply the voltage pulses having the first voltage value for a relatively short period of time to the main body made from unpolarized piezoceramic material. According to one embodiment variant of the method the time period of the first section is therefore less than the time period of the second section. In particular the time period of the first section can be less than or equal to a quarter of the time period of the second section. The time period of the second section of the envelope curve, during which the piezoceramic material is polarized, amounts to e.g. 60 seconds. During this time e.g. 6000 voltage pulses are applied to the main body. The time period of the first section, during which the strain-relieving crack or cracks form, can then amount, for example, to 15 seconds, during which e.g. 1500 electrical voltage pulses are applied to the main body.

The main body may have contaminants, in particular in a passivation layer. Said contaminants do not necessarily result in the piezoelectric actuator for which the main body is used being functionally unserviceable. According to another variant of the method the envelope curve therefore has a third section preceding the first section, the pulse heights of the electrical voltage pulses of the third section having a third voltage value which in particular is less than the second voltage value and is sufficient to incinerate said contamination. The electrical voltage pulses of the third section are provided for the purpose of selectively generating an electrical flashover at the site of the contamination. A spark produced as a result of the flashover can incinerate the contamination without leaving behind a conductive burn site.

The time period that is necessary to ensure the contamination is burned off can likewise be selected to be relatively short. According to an embodiment variant of the method the time period of the first and third section together is less than the time period of the second section. In particular the time period of the first and third section together can be less than or equal to a quarter of the time period of the second section.

The third voltage value (voltage for incinerating the contamination) can be calculated e.g. by first determining the electrical conductivity of the main body made from unpolarized piezoceramic material, as a result of which deductions can be made concerning the extent of the contamination in particular in the passivation layer. The third voltage value can then be set on the basis of the determined extent of the contamination.

The conductivity of the main body made from unpolarized piezoceramic material can be determined, for example, by applying an electrical voltage of in particular around 10V to the electrodes.

If the third electrical voltage value is greater than or equal to the second voltage value, then the third section is not required.

The absolute stability of the piezoelectric actuator for which the main body is used can be increased if, during the polarization of the piezoceramic material, the mean force during the mean stroke to which the piezoelectric actuator is subjected during operation acts in addition. According to an embodiment variant of the method the main body is therefore subjected during the application of the electrical voltage pulses to a force acting against the main body, which force corresponds in particular to a mean value of a force against which a piezoelectric actuator for which the main body is provided works during operation at a mean stroke. This can be achieved, for example, by the main body working against an application-specific spring stiffness or a defined force while the voltage pulses are being applied.

The envelope curve can also have a fourth section following the second section, in which case the pulse heights of the electrical voltage pulses of the fourth section have a fourth voltage value which corresponds to a mean value of an electrical voltage that is applied during the operation of a piezoelectric actuator for which the main body is provided. The time period of the fourth section can be less than the time period of the second section. In particular the time period of the fourth section can be less than or equal to half of the time period of the second section.

The method according to various embodiments can be performed particularly effectively in respect of time if a poling system for the method is operated in such a way that a mechanism of the poling system is implemented such that when the voltage pulses are applied during the second section the effect of the force corresponds only to an injection mean value of the piezoelectric actuator despite maximum voltage.

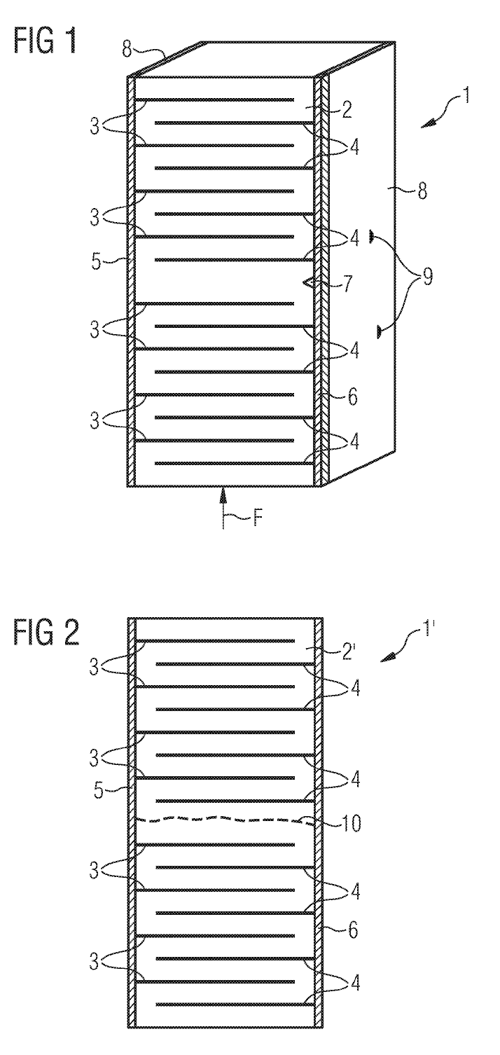

FIG. 1 shows a piezoelectric stack 1 (main body), which in the case of the present exemplary embodiment is implemented in a cuboid shape, in a partially cutaway and perspective representation. The piezoelectric stack 1 has an unpolarized piezoceramic material 2 embodied in a layer structure and a plurality of internal electrodes 3, 4 arranged within the unpolarized piezoceramic material 2 and was produced in a generally known way, for example by means of the process steps of stacking, separating, debinding and polishing. The piezoceramic material 2 has for example lead-zirkonate-titanate and in the case of the present exemplary embodiment the internal electrodes 3, 4 are electrically conductive metal layers which permeate the piezoelectric stack 1.

In the case of the present exemplary embodiment the internal electrodes 3, 4 are electrically connected in alternation to external electrodes 5, 6 arranged on opposite external surfaces of the piezoelectric stack 1 and mounted directly on the lateral surface of the piezoceramic material 2. The internal electrodes 3, 4, which are electrically connected to one of the two external electrodes 5, 6, are therefore brought out as far as the outside at which said external electrode 5, 6 is arranged for the purpose of electrical connection to the external electrode 5, 6. To ensure that the internal electrodes 3, 4 are electrically insulated from the other external electrodes 5, 6, however, the internal electrodes 3, 4 do not reach as far as the outside of the piezoelectric stack 1 at which the other external electrodes 5, 6 are arranged.

In the case of the present exemplary embodiment the lateral surface of the piezoelectric stack 1 is additionally provided with a passivation layer 8 which may contain contaminants 9.

In the case of the present exemplary embodiment the piezoelectric stack 1 also has a predetermined fracture joint 7 due to which a strain-relieving crack 10 shown in FIG. 2 forms if an electrical voltage is applied to the internal electrodes 3, 4.

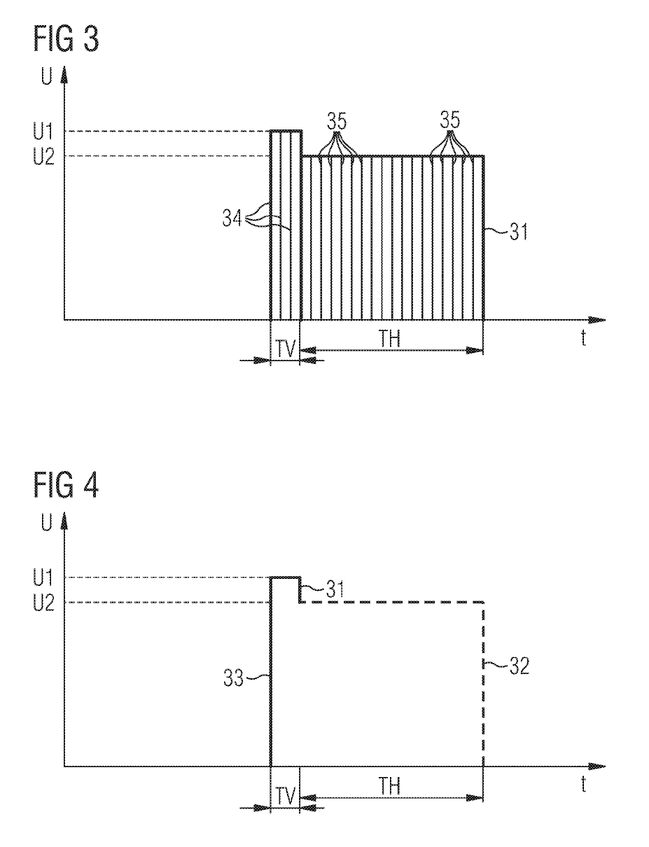

The piezoceramic material 2 of the piezoelectric stack 1 shown in FIG. 1 is still unpolarized and must be polarized in order to have a piezoelectric effect. This is achieved by applying an electrical voltage U to the internal electrodes 3, 4 or, as the case may be, the external electrodes 5, 6, the characteristic curve of the voltage being shown in FIG. 3.

In the case of the present exemplary embodiment the electrical voltage U applied to the piezoelectric stack 1 consists of electrical voltage pulses 34, 35 whose pulse heights follow a time-dependent envelope curve 31. The envelope curve 31, which is shown again in FIG. 4, has a first section 33, indicated by an unbroken line in FIG. 4, and a second section 32 indicated by a dashed line in FIG. 4.

In the case of the present exemplary embodiment the second section 32 of the envelope curve 31 comprises 6000 individual pulses 35, each of which has the same pulse height at an electrical voltage U2. The time period TH of the second envelope curve 32 amounts to e.g. 60 seconds. The electrical voltage U2 is sufficient to polarize the unpolarized piezoceramic material 2 and in the case of the present exemplary embodiment has a value of approx. 160V. If the maximum permissible electrical voltage of a piezoelectric actuator (not shown in further detail) for which the piezoelectric stack 1 is provided is sufficient for polarizing the unpolarized piezoceramic material 2, then the pulse heights of the second section 32 can be equal to said maximum permissible voltage.

In the case of the present exemplary embodiment the time period TV of the first section 33 is significantly shorter than the time period TH of the second section 32 and amounts to e.g. 15 seconds and comprises for example 1500 individual pulses 34. The electrical voltage U1 for the pulse heights of the pulses 34 of the first section is selected such that it is greater than a voltage due to which the strain-relieving crack 10 forms. In the case of the present exemplary embodiment the voltage U1 amounts to approx. 200V.

After the electrical voltage has been applied to the piezoelectric stack 1 there is thus produced a piezoelectric stack 1′ having polarized piezoceramic material 2′, as shown in FIG. 2.

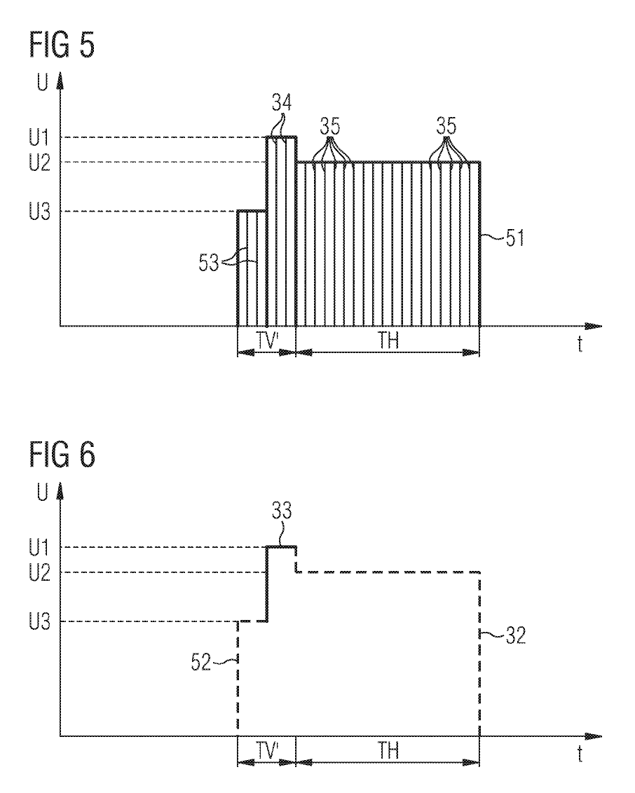

FIG. 5 shows an alternative voltage curve for polarizing the unpolarized piezoceramic material 2 of the piezoelectric stack 1. The voltage curve shown in FIG. 5 consists of the electrical voltage pulses 34, 35 and in addition voltage pulses 53 whose pulse heights together follow a time-dependent envelope curve 51. The envelope curve 51, which is shown again in FIG. 6, has, in addition to the envelope curve 31 shown in FIG. 4, a third section 52, indicated by a dashed line in FIG. 6, which precedes the first section 33.

In the case of the present exemplary embodiment the time periods TV′ of the first and third section 33, 52 together are considerably shorter than the time period TH of the second section 32 and amount to e.g. 15 seconds. The first section 32 and the third section 52 each have e.g. 750 individual pulses 34, 53. The pulse heights of the first section 34 have a voltage value U1, with the result that the strain-relieving crack 10 forms.

In particular the passivation layer 8 may have the contaminants 9. In the case of the present exemplary embodiment these are incinerated by means of the voltage pulses 53 of the third section 52. The pulse heights at an electrical voltage U3 of the electrical voltage pulses 53 of the third section 52 are in this case lower than the voltage U2 of the second section 32. The height of the voltage U3 of the voltage pulses 53 of the third section 52 is determined e.g. by initially determining the electrical conductivity of the piezoelectric stack 1 made of unpolarized piezoceramic material 2, as a result of which deductions can be made concerning the extent of the contamination 9 in the passivation layer 8. The voltage U3 can then be set based on the determined extent of the contamination 9. The conductivity of the piezoelectric stack 1 made from unpolarized piezoceramic material 2 can be determined for example by applying an electrical voltage of in particular around 10V to the internal electrodes 3, 4.

After the electrical voltage has been applied to the piezoelectric stack 1 there is thus produced the piezoelectric stack 1′ having polarized piezoceramic material 2′, as shown in FIG. 2.

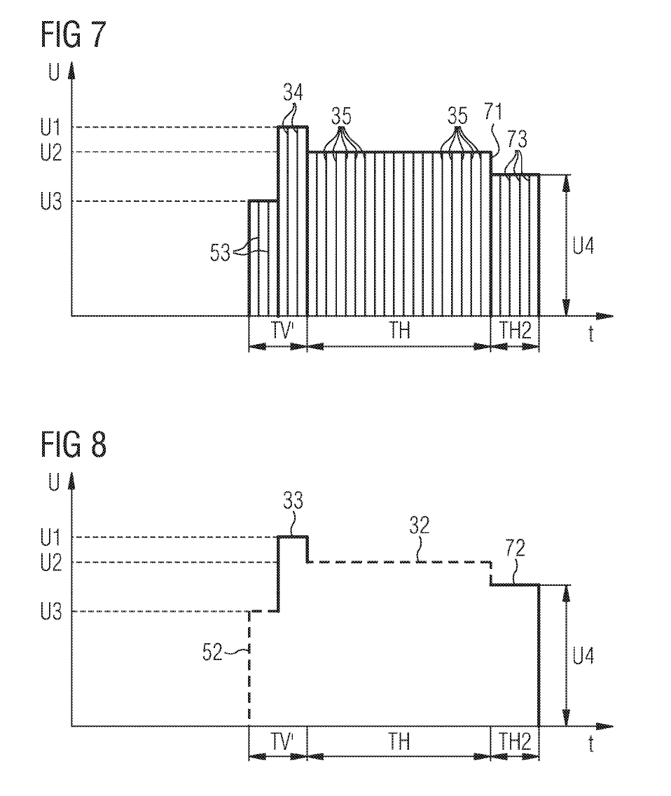

FIG. 7 shows an alternative voltage curve for polarizing the unpolarized piezoceramic material 2 of the piezoelectric stack 1. The voltage curve shown in FIG. 7 relates to the electrical voltage pulses 34, 35, 53 and further voltage pulses 73 whose pulse heights together follow a time-dependent envelope curve 71. The envelope curve 71, which is shown again in FIG. 8, has, in addition to the envelope curve 51 shown in FIG. 6, a fourth section 72, indicated by an unbroken line in FIG. 8, which follows the second section 32.

In the case of the present exemplary embodiment the fourth section 72 of the envelope curve 71 consists of 3000 individual pulses 75, the pulse heights of which have an electrical voltage U4. The time period TH2 of the fourth section 72 amounts to e.g. 30 seconds. The voltage U4 for the voltage pulses 73 of the fourth section 72 corresponds to the mean value of an electrical voltage that is applied during the operation of the piezoelectric actuator for which the piezoelectric stack 1 is provided.

After the electrical voltage has been applied to the piezoelectric stack 1 there is thus produced the piezoelectric stack 1′ having polarized piezoceramic material 2′, as shown in FIG. 2.

In the case of the present exemplary embodiment, during the polarization of the unpolarized piezoceramic material 2, i.e. while the electrical voltage is being applied to the piezoelectric stack 1, this is acted upon during operation by the mean force F at the mean stroke to which the piezoelectric actuator for which the piezoelectric stack 1 is provided is subjected. This can be achieved, for example, by the piezoelectric stack 1 working against an application-specific spring stiffness or a defined force while the voltage pulses 34, 35, 53, 73 are being applied.

What is claimed is:

1. A method for polarizing a piezoceramic material, comprising:
providing a main body made from unpolarized piezoceramic material having at least two electrodes embodied with at least two flat surfaces and disposed opposite each other, and having at least one predetermined fracture joint due to which a strain-relieving crack forms when an electrical voltage having a first electrical voltage value is applied, and
applying a number of electrical voltage pulses to the electrodes, the pulse heights of which voltage pulses follow a time-dependent envelope curve, the pulse heights of the electrical voltage pulses in a first section of the envelope curve being greater than the first electrical voltage value and the pulse heights of the electrical voltage pulses in a second section of the envelope curve following the first section having a second electrical voltage value which is sufficient to produce a permanent polarization of the piezoceramic material.

2. The method according to claim 1, wherein the first electrical voltage value is greater than the second electrical voltage value.

3. The method according to claim 1, wherein the second electrical voltage value is equal to the maximum permissible electrical voltage of a piezoelectric actuator for which the main body is provided.

4. The method according to claim 1, wherein the time period of the first section is less than the time period of the second section.

5. The method according to claim 1, wherein the envelope curve has a third section preceding the first section, the pulse heights of the electrical voltage pulses of the third section having a third voltage value which is less than the second voltage value and is sufficient to incinerate a contaminant.

6. The method according to claim 5, wherein the time period of the first and the third section together is less than the time period of the second section.

7. The method according to claim 5, further comprising:
determining the electrical conductivity of the main body made from unpolarized piezoceramic material, deducing the degree of contamination and setting the third voltage value based on the determined degree of contamination.

8. The method according to claim 1, further comprising:
applying an electrical voltage to the electrodes in order to determine the electrical conductivity of the main body made from unpolarized piezoceramic material.

9. The method according to claim 1, further comprising:
applying to the main body, while the electrical voltage pulses are being applied, a force acting against the main body, which force corresponds to a force against which a piezoelectric actuator for which the main body is provided works at a mean stroke during operation.

10. The method according to claim 1, wherein the envelope curve has a fourth section following the second section, the pulse heights of the electrical voltage pulses of the fourth section having a fourth voltage value which corresponds to a mean value of an electrical voltage that is applied during the operation of a piezoelectric actuator for which the main body is provided.

11. The method according to claim 10, wherein the time period of the fourth section is less than the time period of the second section.

12. The method according to claim 1, wherein the time period of the first section is less than or equal to a quarter of the time period of the second section.

13. The method according to claim 1, wherein the envelope curve has a third section preceding the first section, the pulse heights of the electrical voltage pulses of the third section having a third voltage value which is less than the second voltage value and is sufficient to incinerate a contaminant in a passivation layer of the main body.

14. The method according to claim 13, wherein the time period of the first and the third section together is less than or equal to a quarter of the time period of the second section.

15. The method according to claim 8, wherein the electrical voltage is around 10V.

16. The method according to claim 1, further comprising:
applying to the main body, while the electrical voltage pulses are being applied, a force acting against the main body, which force corresponds to a mean value of a force against which a piezoelectric actuator for which the main body is provided works at a mean stroke during operation.

17. The method according to claim 10, wherein the time period of the fourth section is less than or equal to half of the time period of the second section.

18. A system for polarizing a piezoceramic material, comprising:
a main body made from unpolarized piezoceramic material having at least two electrodes embodied with at least two flat surfaces and disposed opposite each other, and having at least one predetermined fracture joint due to which a strain-relieving crack forms when an electrical voltage having a first electrical voltage value is applied, and
means for applying a number of electrical voltage pulses to the electrodes, the pulse heights of which voltage pulses follow a time-dependent envelope curve, the pulse heights of the electrical voltage pulses in a first section of the envelope curve being greater than the first electrical voltage value and the pulse heights of the electrical voltage pulses in a second section of the envelope curve following the first section having a second electrical voltage value which is sufficient to produce a permanent polarization of the piezoceramic material.

19. The system according to claim 18, wherein the first electrical voltage value is greater than the second electrical voltage value.

20. The system according to claim 18, wherein the second electrical voltage value is equal to the maximum permissible electrical voltage of a piezoelectric actuator for which the main body is provided.
